(19) United States
(12) Patent Application Publication
(10) Pub. No.: US 2005/0017383 A1
(43) Pub. Date: Jan. 27, 2005

(54) Method for producing polymeric optical waveguide and device for producing the same

(75) Inventors: Keishi Shimizu, Ashigarakami-gun (JP); Shigemi Ohtsu, Ashigarakami-gun (JP); Kazutoshi Yatsuda, Ashigarakami-gun (JP); Eiichi Akutsu, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/795,285

(22) Filed: Mar. 9, 2004

(30) Foreign Application Priority Data
Jul. 22, 2003 (JP) 2003-277466

(51) Int. Cl. B29D 11/00

(52) U.S. Cl. 264/1.24; 425/388; 425/546

(57) ABSTRACT

The present invention relates to a method for producing a polymeric optical waveguide, comprising: preparing a mold having, on a surface thereof, a branched concave portion for forming a core; bringing a clad substrate into close contact with the surface of the mold having the branched concave portion; filling the branched concave portion with a core-forming curable resin by supplying and sucking the core-forming curable resin from one end of the branched concave portion into the branched concave portion toward another end of the branched concave portion which is provided opposite the one end while the remaining ends of the branched concave portion are closed, by opening the closed ends, and by sucking the core-forming curable resin into portions communicating with the opened ends; and curing the core-forming curable resin; and a production device used for the above method.

### CROSS-REFERENCE TO RELATED APPLICATION

This application claims priority under 35 U.S.C. 119 from Japanese Patent Application No. 2003-277466, the disclosure of which is incorporated by reference herein.

### BACKGROUND OF THE INVENTION

1. Field of the Invention

The present invention relates to a method and a device for producing at low cost a polymeric optical waveguide, and particularly a flexible polymeric optical waveguide.

2. Description of the Related Art

In producing a polymeric optical waveguide, the following methods have been proposed: (1) a method in which a film is impregnated with a monomer, and the core portion is selectively exposed to light to change the refractive index in the portion and the film is then laminated on a substrate (selective polymerization method), (2) a method in which a core layer and a clad layer are applied to a substrate and then a clad portion is formed by using reactive ion etching (RIE method), (3) a method using a photolithographic method in which an ultraviolet ray-curable resin obtained by adding a light-sensitive material to a polymer material is used, exposed to UV light and developed (direct exposure method), (4) a method using injection molding and (5) a method in which a core layer and a clad layer are applied to a substrate and then a core is exposed to light to change the refractive index of the core (photo-bleaching method).

However, the selective polymerization method (1) has a problem in lamination of the film, methods (2) and (3) are expensive because a photolithographic method is used, and method (4) has a problem in accuracy of a core diameter. Also, method (5) has a problem in that a sufficient difference between the refractive index of the core layer and that of the clad layer cannot be obtained. Only methods (2) and (3) are currently practical methods for providing waveguides with high performance. However, none of these methods are suitable for the formation of a polymeric optical waveguide on a flexible plastic substrate having a large area.

Also, in producing a polymeric optical waveguide, a method is known in which a pattern substrate (clad) with a groove pattern which is to be a capillary is prepared, and the groove is filled with a polymer precursor material for a core, and the polymer precursor material is then cured to form a core layer, and a plane substrate (clad) is laminated on the surface of the core layer. However, this method has a problem in that not only the capillary groove is filled with the polymer precursor material but also the polymer precursor material spreads the entire surface of the pattern substrate and the polymer precursor material of the surface of the pattern substrate is also cured to form a thin layer having the same composition as the core layer, resulting in light leaking through this thin layer.

As One of the methods to solve this problem, David Heart has proposed a method for producing a polymeric optical waveguide in which a pattern substrate with a groove pattern which is to be a capillary is brought into close contact with a plane substrate by using a clamping jig and the capillary is filled with a monomer solution under a reduced pressure and the monomer is polymerized (see Japanese patent No. 3151364).

However, this method is complicated because if the clamp is not used to bring the pattern substrate into close contact with the plane substrate, the monomer solution also enters parts other than the core and therefore a precise waveguide structure cannot be formed. This method has another drawback in that the volume Of the monomer solution changes when undergoing polymerization to form a macromolecule (solidification), leading to change in a core shape. Moreover, still another drawback is that the core shape collapses at the time of removal of the capillary because a polymer obtained by the polymerization of the monomer solution is partially brought into close contact with the capillary.

George M. whitesides et al., of Harvard University have recently proposed a method called “capillary micro-mold” as one of soft lithographic methods in new technologies for making a nano-structure. This is a method in which a master substrate is made using photolithography, the nano-structure of the master substrate is exactly copied on a mold of a polydimethylsiloxane (PDMS) by utilizing the adhesiveness and easy releasability of the PDMS, and a liquid polymer is infused into the mold by utilizing a capillary phenomenon and solidified (see, for example, SCIENTIFIC AMERICAN September 2001 (Nikkei Science, December 2001 issue).

Also, Kim Enoch et al., from the group of George M. Whitesides, of Harvard University, have filed a patent application concerning a capillary micro-mold method (see U.S. Pat. No. 6,355,198).

However, the production method described in this patent is unsuitable for mass-production since a long period of time is required to form a core of an optical waveguide, the sectional area of which core is small. This method also has a drawback in that the volume of the monomer solution changes when the monomer solution is reacted and solidified, causing change in the core shape and increased transmission loss (waveguide loss).

The inventors of the invention have already proposed a method for producing a polymeric optical waveguide with precisely maintained core shape and reduced waveguide loss and insertion loss by reproducing a polymeric optical waveguide utilizing a capillary phenomenon (see, for example, Japanese Patent Application No. 2002-187473). In this method, much time may be required to fill space for a core with a core-forming curable resin to form a core, particularly a long core, leading to low productivity.

With respect to this problem, Sugiyama et al. have proposed a method using plural filling ports (see, for example, Japanese Patent Application Laid-Open (JP-A) No. 2002-90565). This method has an advantage in that a branched type ring-like waveguide can be formed without any additional process. However, plural branched filling ports must be removed by precise processing to produce an waveguide having a desired shape, which leads to increased costs and also causes increased waveguide loss depending on the processing accuracy.

Also, the inventors of the invention have proposed a method in which a curable resin is brought into contact with and infused into a resin inlet disposed at the end of a mold and sucked under a reduced pressure from a resin outlet to accelerate the introduction of the curable resin by suction (see, for example, Japanese Patent Application No. 2002-345909). This method is very effective in the case of an waveguide having no branched structure. However, if this method is applied to the formation of an waveguide having a branched structure, a part of a core cannot be well filled and, when the resin is sucked, air may be introduced to the resin, forming an waveguide with a formed core having defects.

Therefore, there is a strong demand for a simple method and a device for producing at low cost a polymeric optical waveguide with reduced waveguide loss, particularly, a branched waveguide and a large-area waveguide.

### SUMMARY OF THE INVENTION

The inventors of the invention have found a production method which not only can shorten filling time but is also free from waveguide defects in producing a polymeric optical waveguide with reduced waveguide loss and insertion loss while precisely maintaining a core shape by utilizing a capillary phenomenon, which method has been proposed by the inventors.

A method has been proposed in which a curable resin is introduced from an end of a concave portion on one side of a branch of a mold corresponding to a branched waveguide toward an outlet from which the resin is sucked on the other side of the branch and, at the same time, a concave end which is not an inlet is closed to thereby prevent air from being confined in the inside of the filled resin whereby not only filling time is shortened by using suction even in a branched waveguide but also the introduction of air to the resin is prevented.

A first aspect of the invention is to provide a method for producing a polymeric optical waveguide, comprising: preparing a mold having, on a surface thereof, a concave portion for forming a core; bringing a clad substrate into close contact with the surface of the mold having the concave portion; filling the concave portion with a core-forming curable resin; and curing the core-forming curable resin; wherein the concave portion has branched concave portions and a branch junction, and each of the branched concave portions has, as a concave end, one end which is exposed, and the branch junction has at least one end thereof communicating with the other end of each of the branched concave portions; the filling is conducted by: bringing the core-forming curable resin into contact with, as a resin inlet or inlets, one of the concave ends or at least two of the concave ends of the branched concave portions disposed at a same side of the mold and having the same length, using, as a resin outlet or outlets, at least one concave end disposed opposite the resin inlet or inlets, closing a remaining concave end or ends in an arbitrary order; supplying the core-forming curable resin to the resin inlet or inlets and sucking the core-forming curable resin from the resin outlet or outlets to fill a part of the concave portion with the core-forming curable resin; opening the closed concave end or ends; and sucking the core-forming curable resin from the opened concave end or ends to fill a remaining part of the concave portion with the core-forming curable resin.

A second aspect of the invention is to provide a device for producing a polymeric optical waveguide, comprising: a resin supply unit for supplying a core-forming curable resin into a concave portion of a mold brought into close contact with a clad substrate; a movable lid; and a suction unit for reducing an internal pressure of the concave portion; wherein the concave portion has branched concave portions and a branch junction, and each of the branched concave portions has, as a concave end, one end which is exposed, and the branch junction has at least one end thereof communicating with the other end of each of the branched concave portions; the resin supply unit is to be attached to one of the concave ends or at least two of the concave ends of the branched concave portions disposed at a same side of the mold and having the same length; the suction unit is to be attached to at least one of the concave ends at the other side of the mold, and the movable lid is to be attached to a remaining concave end or ends.

According to the invention, a highly precise polymeric optical waveguide with reduced waveguide loss can be produced by a simple method at low cost and a flexible polymeric optical waveguide which is excellent in mass-productivity and has a high degree of freedom can be produced. In particular, in the case of an waveguide having a branched structure, not only filling time can be shortened by using suction but also an waveguide free from any defects can be produced.

### BRIEF DESCRIPTION OF THE DRAWINGS

Preferred embodiments of the invention will be described in detail based on the following figures, wherein:

FIG. 1 is a plane view of one example of a mold in the invention;

FIG. 2 is a plane view of an integrated body of the mold shown in FIG. 1 and a clad substrate as viewed from the mold side;

FIGS. 3A and 3B are sectional views of the integrated body of the mold and the clad substrate shown in FIG. 2 along the lines A-A and B-B′;

FIGS. 4 and 5 are plane views showing the introduction of a curable resin into the space formed by the concave portion of the mold and the clad substrate shown in FIG. 2;

FIG. 6 is a plane view showing a state in which the space formed by the concave portion of the mold and the clad substrate is completely filled with the curable resin;

FIG. 7 is a plane view showing one example of a state in which the concave portion is not filled completely with the curable resin;

FIG. 8 is a plane view showing another example of a state in which the concave portion is not filled completely with the curable resin;

FIG. 9 is a schematic view showing one example of a resin supply unit in the invention;

FIG. 10 is a plane view showing another example of a mold in the invention.

### DETAILED DESCRIPTION OF THE INVENTION

The present invention will be hereinafter explained in detail.

Method for Producing Polymeric Optical Waveguide

A method for producing a polymeric optical waveguide according to the invention ensures that a mold having a highly precise core shape is produced by a simple method utilizing a micro-molding method and a mold-forming elastomer, a typical example of which is a polydimethylsiloxane (PDMS), only a concave portion of the mold is filled with an ultraviolet ray-curable resin or a thermosetting resin by utilizing strong adhesiveness between a film having a low refractive index or the like as a clad layer and the mold-forming elastomer and the resin is solidified to form an waveguide core, the mold is removed from a formed body and then the clad layer is applied to the formed body and solidified to form a polymeric optical waveguide at low cost.

In the invention, a flexible film substrate or rigid substrate on the surface of which a core layer is formed serves as the clad layer. A product in which a core layer (core) having a higher refractive index than a film or a rigid body is formed on the surface of the film or rigid body functions as a polymeric optical waveguide. At this time, a micro-molding method using a mold-forming elastomer, a typical example of which is PDMS, is used to form the core. The mold-forming elastomer has excellent adhesiveness to and releasability from a substrate and has the ability to copy a nano-structure. Therefore, when brought into close contact with a substrate, the mold-forming elastomer can prevent ingress of liquid. Moreover, when capillaries are formed with a film substrate and a mold made of the mold-forming elastomer, only the capillaries are filled with liquid. Furthermore, the PDMS mold has high releasability. Therefore, it can be easily removed from a formed product even if it is brought into close contact with the product. Namely, when a mold made of PDMS is filled with a resin and the resin is solidified, the mold can be separated from the solidified resin while retaining the resin shape with high precise. Therefore, this method is very effective as a method for forming the core or the like of an optical waveguide.

With regard to such a method for producing a polymeric optical waveguide, the inventors of the invention have found a new method as a good method for forming a core having branched portions.

Specifically, the method for producing a polymeric optical waveguide according to the invention includes: preparing a mold having, on a surface thereof, a concave portion for forming a core; bringing a clad substrate into close contact with the surface of the mold having the concave portion; filling the concave portion with a core-forming curable resin; and curing the core-forming curable resin; wherein the concave portion has branched concave portions and a branch junction, and each of the branched concave portions has, as a concave end, one end which is exposed, and the branch junction has at least one end thereof communicating with the other end of each of the branched concave portions; the filling is conducted by: bringing the core-forming curable resin into contact with, as a resin inlet or inlets, one of the concave ends or at least two of the concave ends of the branched concave portions disposed at a same side of the mold and having the same length, using, as a resin outlet or outlets, at least one concave end disposed opposite the resin inlet or inlets, closing a remaining concave end or ends in an arbitrary order; supplying the core-forming curable to the resin inlet or inlets and sucking the core-forming curable resin from the resin outlet or outlets to fill a part of the concave portion with the core-forming curable resin; opening the closed concave end or ends; and sucking the core-forming curable resin from the opened concave end or ends to fill a remaining part of the concave portion with the core-forming curable resin.

Meanwhile, the inventors of the invention improved a method in which a clad substrate is brought into close contact with a mold having a concave portion, and one of both ends (concave ends) where the concave portion is exposed is brought into contact with a core-forming curable resin, and the curable resin is introduced into the concave portion by a capillary phenomenon. In the improved method, the entire surface of the concave end serving as the resin inlet is brought into contact with the curable resin, and the curable resin is sucked from the other concave end serving as the resin outlet under a reduced pressure to thereby accelerate the introduction of the curable resin.

This method is very effective when an waveguide having a non-branched structure is produced. However, if this method is applied to the production of an waveguide having a branched structure (branched portions), especially an waveguide including branched portions having different lengths, a resin would be sucked and introduced simultaneously from the resin inlets into the concave portion of the mold, and shorter branched portions would be first filled with the resin, and the resin discharged from the shorter branched portions might first reach the branch junction, and then the branch junction and branched portions serving as resin outlets might be filled with the resin. As a result, longer branched portions would not be completely filled with the resin.

Moreover, in the production of the waveguide having the above branched structure, a concave end other than the resin inlet(s), which is brought into contact with the resin, and the resin outlet(s), from which the resin is sucked, may exist and is left open. In such a case, when the resin is sucked, air may be introduced from such a concave end into the concave portion, causing defects in the inside of the resultant waveguide core. Meanwhile, when the introduction of the resin is conducted not by suction but by a capillary phenomenon, such defects are not caused but filling speed is low.

In the invention, in order to adapt to the production of an waveguide having a branched structure, a method has been proposed in which at least one of plural concave ends formed on one side of the branched structure is used as a resin inlet, and at least one of plural concave ends formed on the other side of the branched structure is used as a resin outlet, and the remaining concave ends which are not involved in the resin introduction and suction are closed, and a curable resin is sucked from the resin outlet to introduce the curable resin into the concave portion, thereby preventing air from being confined inside of the resin used in the core formation. The method not only can shorten filling time but also can produce an waveguide having no defect by using suction even when an waveguide having a branched structure is produced.

Hereinafter, a method for producing a polymeric optical waveguide according to the invention, each step thereof and a device for producing a polymeric optical waveguide according to the invention will be explained.

-Preparation of Mold-

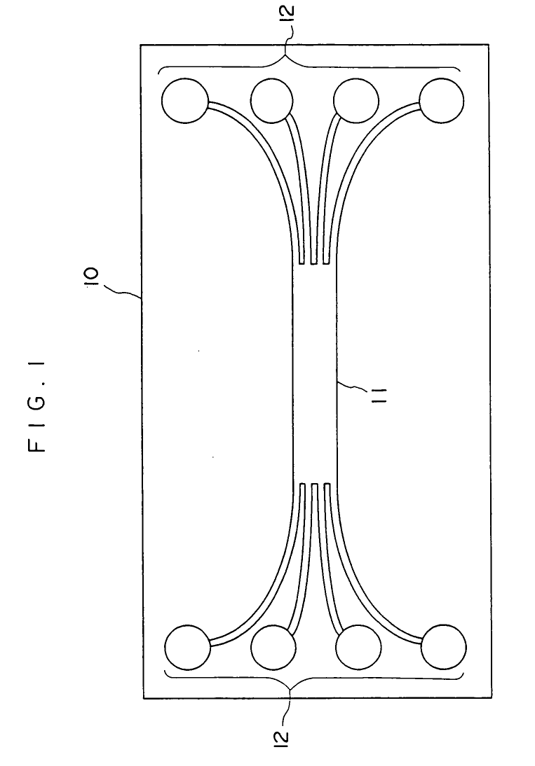

First, a mold is prepared. One embodiment of a mold used in the invention is shown in FIG. 1. FIG. 1 is a plane view of a mold for a star coupler waveguide having a four-branched structure. In FIG. 1, a mold 10 has a concave portion corresponding to a core. The concave portion includes a branch junction (central concave portion) 11 located in the center of the mold 10, four branched concave portions communicating with one end of the branch junction 11 and extending in four directions, and another four branched concave portions communicating with the other end of the branch junction 11 and extending in another four directions. Eight vertical through-holes 12 penetrating the mold 10 parallel to the thickness of the mold 10 and corresponding to the outer ends of the eight branched concave portions are independently formed in the mold 10 and communicating with the outer end of the corresponding branched concave portion to expose the branched concave portion, and the outer end of each branched concave portion at which outer end the branched concave portion communicates with the corresponding through-hole serves as a concave end.

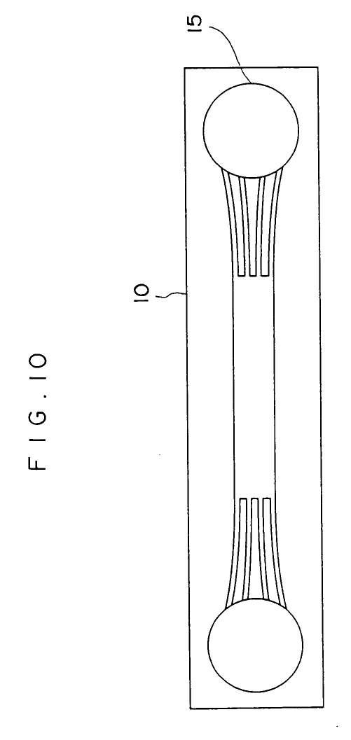

Another embodiment of a mold used in the invention is shown in FIG. 10. The mold is the same as the above mold, except that two through-holes are provided and each through-hole communicates with the outer ends of the corresponding branched concave portions.

The diameter of each through-hole is preferably in the range of 0.1 to 10 mm and more preferably in the range of 1 to 3 mm.

In the invention, the axial direction of the through-hole is not limited to a vertical direction (direction parallel to the thickness of the mold) and can be provided obliquely.

Moreover, in the invention, holes can be omitted as long as the outer ends of the branched concave portions are exposed to enable the introduction of a resin into the mold.

The mold can be prepared by preparing a mold precursor with a master plate having a convex portion corresponding to the concave portion of the mold, separating the mold precursor from the master plate and exposing the outer ends of the concave portion, but the invention is not limited to such a method.

For the production of the master plate, conventional methods, for example, a photolithographic method or an RIE method may be used without any particular limitation. Moreover, the method for producing a polymeric optical waveguide by using an electrodeposition method or a photo-electrodeposition method, which method was proposed by the applicant of the present application may also be used for the production of the master plate.

As a material of the master plate, a silicon substrate, a glass substrate or the like is used. The size of the convex portion formed on the master plate is properly determined according to, for example, the use of the polymeric optical waveguide. For example, a square core whose edge length is about 8 μm is usually used in the case of a single mode optical waveguide and a square core whose edge length is about 50 to 100 μm is usually used in the case of a multi-mode optical waveguide. An Optical waveguide with a large core having an edge length of several hundreds μm is utilized according to the use thereof.

As mentioned above, the convex portion corresponding to the core is formed on the master plate. Because the core in the invention has branched portions, the convex portion must also have a shape having a branched structure. The above branched structure may be, for example, a structure (1×2) in which one line is connected to branched two lines at one end of the line or a structure (4×4) in which one line is connected to four branched lines at one end of the line and four branched lines at the other end of the line. However, the invention is not limited to these structures provided that the convex portion has at least one branch.

The mold precursor is produced by forming a mold elastomer layer on the surface of the thus prepared master plate on which surface the convex portion is formed and then by separating the mold-forming elastomer layer from the master plate.

It is preferable that the mold elastomer can be easily separated from the master plate and has sufficient mechanical strength and dimensional stability which a mold, that is repeatedly used, is required to have. The mold elastomer layer is made of a mold elastomer optionally including any additive.

The mold-forming elastomer preferably has a viscosity of less than a certain limit, for example, in the range of about 2000 to about 7000 mPa•s because it must exactly copy the shape of the convex portion of the master plate. A solvent may be added to the mold-forming elastomer to such an extent that the solvent does not adversely affects the performance of a finally formed product so as to regulate the viscosity of the elastomer.

The viscosity may be measured by an ordinary rotational viscometer.

The mold-forming elastomer is preferably a curable organopolysiloxane which is cured to form a silicone rubber or a silicone resin from the viewpoints of releasability, mechanical strength, dimensional stability, hardness and adhesiveness to a clad substrate as mentioned above. The curable organopolysiloxane preferably includes a methylsiloxane group, an ethylsilaxane group or a phenylsiloxane group in the molecule thereof. Also, the curable organopolysiloxane may be one-component one or two-component one used together with a hardener, and may be thermosetting one, or one which can be cured at an ambient temperature (for example, those cured by moisture in air) or one utilizing other curing methods (e.g., ultraviolet ray-curing).

The curable organopolysiloxane is preferably one which is cured to form a silicone rubber. Compounds which are generally called a liquid silicone rubber (the phrase “liquid silicone rubber” includes those having a high viscosity like paste) are used as such. A two-component liquid silicone rubber used together with a hardener is preferably used. Among two-component liquid silicone rubbers, an addition type liquid silicone rubber is preferably used. This is because it is cured uniformly at the surface and in the inside thereof in a short period of time, and no or a little byproduct is produced at the time of curing, and the addition type liquid silicone rubber has high releasability and a small shrinkage factor.

Among the liquid silicone rubbers, a liquid dimethylsiloxane rubber is particularly preferable from the viewpoint of controllability of adhesiveness, releasability, strength and hardness. Because the cured product of the liquid dimethylsiloxane rubber generally has a low refractive index of about 1.43, a mold made from the liquid dimethylsiloxane may be utilized as the clad layer as it is without removing it from a clad substrate. In this case, it is necessary to secure that the mold, the introduced core-forming resin and the clad substrate do not separate from each other.

The viscosity of the liquid silicone rubber is preferably about 500 to 7000 mPa•s and more preferably about 2000 to 5000 mPa•s from the viewpoints of exact copy of the convex portion corresponding to the core of the optical waveguide, easy defoaming due to decreasing the ingress of air bubbles thereto and the formation of a mold having a thickness of several millimeters.

The master plate is preferably subjected to releasing treatment such as application of a releasing agent in advance to facilitate the separation of the mold precursor from the master plate.

In order to form a mold-forming elastomer layer on the surface of the master plate which surface is provided with the convex portion, the mold-forming elastomer is applied or injected to the master plate and the resultant layer is dried and cured according to the need. Thereafter, the mold-forming elastomer layer is separated from the master plate and is used as a mold precursor.

The mold-forming elastomer is preferably PDMS since it has a low refractive index of about 1.43.

The thickness of the mold precursor produced in this manner is properly determined in consideration of handling properties which a mold is required to have. The thickness of the mold used in the device for producing a polymeric optical waveguide according to the invention which device will be explained later is preferably in the range of 0.1 to 50 mm.

Next, the outer ends (concave ends) of the branched concave portions are exposed. In the invention, the concave portion corresponds to the convex portion formed on the mold and has branched concave portions extending outward from the ends of the branch junction. The concave ends are formed such that all the branched concave portions are exposed at both end portions of the mold surface. The concave ends are formed, for example, by cutting both ends of the mold. The reason why the concave ends are formed such that the branched concave portions are exposed is that the introduction of an ultraviolet ray-curable resin or a thermosetting resin into one of the exposed concave ends which is used as a resin inlet and the sucking of the introduced resin from another concave end(s) which is used as a resin outlet in the subsequent step are enabled.

In the formation of the concave ends, for example, a cutter or the like is used to cut both ends of the mold. However, when concave ends are formed by forming holes extending parallel to the thickness of the mold used in a device for producing a polymeric optical waveguide of the invention explained later, punching with a puncher can be conducted. Various measures may be used insofar as the branched concave portions can be exposed.

The surface energy of the mold is preferably in the range of 10 to 30 mN/m and more preferably in the range of 15 to 24 mN/m in light of adhesiveness between the mold and a film substrate. The surface energy can be obtained by measuring the contact angle between the mold and any solvent whose surface tension is known.

The shore rubber hardness of the mold is preferably in the range of 15 to 80° and more preferably in the range of 20 to 60° in view of patterning performance and releasability. The rubber hardness of the mold may be measured with a durometer.

The surface roughness (root mean square roughness (RMS) Rq) of the mold is preferably 0.5 μm or less and more preferably 0.1 μm or less in view of patterning performance. The surface roughness of the mold may be measured with a contact type surface roughness tester (α step 500, manufactured by KLA-Tencor Corporation).

Also, the mold is preferably light-transmittable in the ultraviolet region and/or the visible region. The reason why the mold is preferably light-transmittable in the visible region is that the mold can be easily aligned on a clad substrate when brought into close contact with the clad substrate in the step which will be explained later and that the state in which the concave portion of the mold is being filled with a core-forming curable resin can be observed and that the finish of the filling work in the introduction of the core-forming curable resin into the mold can be easily confirmed. Also, the reason why the mold is preferably light-transmittable in the ultraviolet region is that, when an ultraviolet ray-curable resin is used as the core-forming curable resin, the resin can be cured by ultraviolet rays through the mold. The transmittance of the mold in the ultraviolet region (250 nm to 400 nm) is preferably 80% or more.

-Bringing Mold into Close Contact with Clad Substrate-

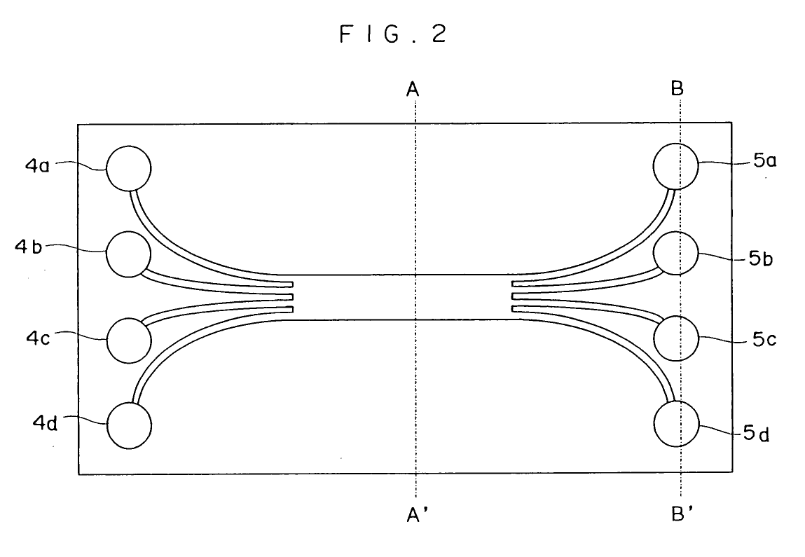

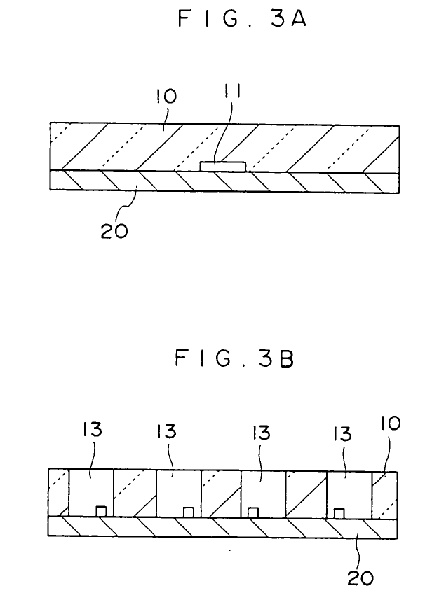

Next, the mold is brought into close contact with a clad substrate. FIG. 2 is a plane view of a contact body in which the mold 10 shown in FIG. 1 and a clad substrate 20 are brought into close contact with each other as viewed from the mold side. In FIG. 2, the eight through-holes 12 in FIG. 1 are designated respectively as 4a, 4b, 4c, 4d, 5a, 5b, 5c and 5d. FIGS. 3A and 3B are sectional views of the mold-clad substrate contact body shown in FIG. 2 along lines AA′ and BB′, respectively. As is clear from FIG. 3A, a concave portion corresponding to the branch junction 11 is shown in the substantial center of the mold 10. Moreover, four exposed concave ends 13 at which through-holes 12 communicate with the corresponding branched concave portion are shown in FIG. 3B.

The polymeric optical waveguide produced by the invention may be used for optical wirings, wavelength-separating devices and the like between a coupler and a board. A proper material is selected as a clad substrate in consideration of optical characteristics such as the refractive index and light transmittance thereof, mechanical strength, heat resistance, adhesiveness to the mold and flexibility of the material according to the use of the polymeric optical waveguide.

As the clad substrate, a glass substrate, a ceramic substrate, a plastic substrate or the like may be used without any particular limitation. A substrate in which the above-mentioned substrate is coated with a resin may also be used to control the refractive index of the substrate.

Specifically, examples of the clad layer include films used as the clad substrate, a layer obtained by applying a curable resin (an ultraviolet ray-curable resin or a thermosetting resin) and curing the resin and a polymer film obtained by applying the solution of a polymer material and drying the resultant coating. When a film is used as the clad layer, the film is adhered to the clad substrate with an adhesive. In this case, the refractive index of the adhesive is preferably close to that of the film.

The refractive index of the clad substrate is preferably less than 1.55 and more preferably less than 1.53 to secure a sufficient difference between the refractive index of the core and that of the clad layer. It is preferable that the refractive index of the clad layer be the same as that of the film substrate from the viewpoint of confining light in the core. The refractive index of the clad substrate must be smaller than that of the core material.

The refractive indexes of the clad substrate, the core material and the like are measured with, for example, an Abbe's refractometer.

The clad substrate is preferably flat, and preferably has such adhesiveness to the mold that no space except the concave portion of the mold exists between the clad substrate and the mold when the clad substrate and the mold are brought into close contact with each other. When the clad substrate can be insufficiently brought into contact with the mold and/or the core, treatment in an ozone atmosphere or radiation treatment of ultraviolet rays having a wavelength of 300 nm or less is preferably carried out to improve the adhesiveness of the clad substrate to the mold and the like.

In the invention, a curable resin is introduced from a resin inlet as will be explained later. Also, a pushing operation using a pin (resin extruding member) is conducted. Therefore, the clad substrate is preferably flat and rigid in order to prevent unnecessary deformation caused by the above operations and to improve workability. When a flexible film substrate is used as the clad substrate, the same effect can be obtained by supporting the backface of the flexible film substrate with a flat rigid material, for example, a glass substrate at the time of producing the optical waveguide.

Examples of materials for the film substrate include acrylic resins (e.g., polymethylmethacrylate), alicyclic acrylic resins, styrene resins (e.g., polystyrene and an acrylonitrile/styrene copolymer), olefin resins (e.g., polyethylene, polypropylene and an ethylene/propylene copolymer), alicyclic olefin resins, vinyl chloride resins, vinylidene chloride resins, vinyl alcohol resins, vinylbutyral resins, acrylate resins, fluorine-containing resins, polyester resins (e.g., polyethylene terephthalate and polyethylene naphthalate), polycarbonate resins, cellulose diacetate and cellulose triacetate, amide resins (e.g., aliphatic or aromatic polyamides), imide resins, sulfone resins, polyether sulfone resins, polyether ether ketone resins, polyphenylene sulfide resins, polyoxymethylene resins, and mixtures of these resins.

When the film substrate does not possess very strong adhesiveness to the mold and/or the core, it is preferable to carry out treatment in an ozone atmosphere or treatment irradiating ultraviolet rays having a wavelength of 300 nm or less so as to improve adhesiveness between the film substrate and the mold and the like.

The film substrate is preferably made of an alicyclic acrylic resin, an alicyclic olefin resin, cellulose triacetate or a fluorine-containing resin since these resins have a relatively low refractive index and transparency.

As the alicyclic acrylic resin, OZ-1000™, and OZ-1100™ (manufactured by Hitachi Chemical Co., Ltd.) obtained by introducing an aliphatic cyclic hydrocarbon such as tricyclodecane to an ester substituent are used.

Moreover, the alicyclic olefin resin film is preferably used in the invention since it has transparency and a low refractive index. Examples of the alicyclic olefin resin include those having a norbornene structure in the main chain thereof and those having a norbornene structure in the main chain thereof and a polar group such as an alkyloxycarbonyl group (the alkyl group thereof is that having 1 to 6 carbon atoms or a cycloalkyl group) in the side chain thereof. Among these compounds, the alicyclic olefin resins having a norbornene structure in the main chain thereof and a polar group such as an alkyloxycarbonyl group in the side chain thereof are particularly suitable to the production method for the polymeric optical waveguide of the invention, because these resins have excellent optical characteristics such as a low refractive index (the refractive index is in the vicinity of 1.50, securing the difference between the refractive index of the core and that of the clad) and excellent light-transmittance, and high adhesiveness to the mold and excellent heat resistance. Examples of such an alicyclic olefin resin include Arton Film (manufactured by JSR Corporation) and Zenoa Film (manufactured by Nippon Zeon Co., Ltd.).

The refractive index of the film substrate is preferably less than 1.55 and more preferably less than 1.53 to secure the difference between the refractive index of the core and that of the film substrate. The thickness of the film substrate is properly selected in consideration of flexibility, rigidity and easy handling and is preferably about 0.1 mm to 0.5 mm in general.

-Filling Concave Portion with Curable Resin-

Filling space formed by the concave portion of the mold and the clad substrate is conducted as follows. First, a concave end serving as a resin inlet is brought into contact with a core-forming curable resin and the core-forming curable resin is supplied and the curable resin is sucked from another concave end serving as a resin outlet to fill the concave portion with the resin.

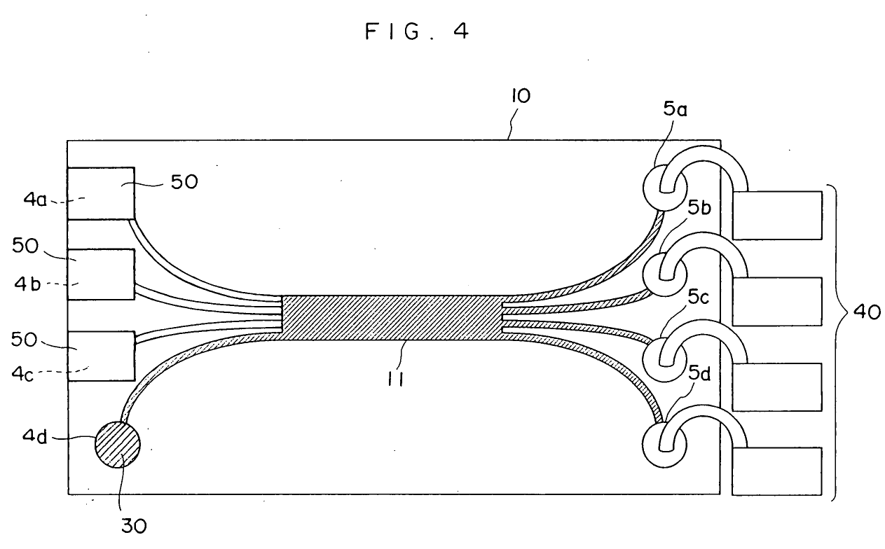

FIGS. 4 to 6 show a typical example of introducing a curable resin into the concave portion of a mold in the method for producing a polymeric optical waveguide according to the invention.

As shown in FIG. 4, a core-forming curable resin 30 is introduced from the through-hole 4d to fill the through-hole 4d and to bring the curable resin 30 into contact with the entire of the concave end communicating with the through-hole 4d. Then, the resin is sucked by a suction unit 40 into the branched concave portion connecting the through-hole 4d and one end of the branch junction 11, the branch junction 11 and branched concave portions communicating with the other end of the branch junction 11 toward the through-holes 5a, 5b, 5c and 5d while the supply of the resin to the through-hole 4d is continued. At this time, the other through-holes 4a, 4b and 4c which are not being involved in the resin introduction and suction are closed by, for example, movable lids 50. When the suction is finished, the branched concave portion connecting the through-hole 4d and the branch junction 11, the branch junction 11, and the branched concave portions connecting the branch junction 11 and the through-holes 5a, 5b, 5c and 5d, respectively, have been filled completely without any suction void.

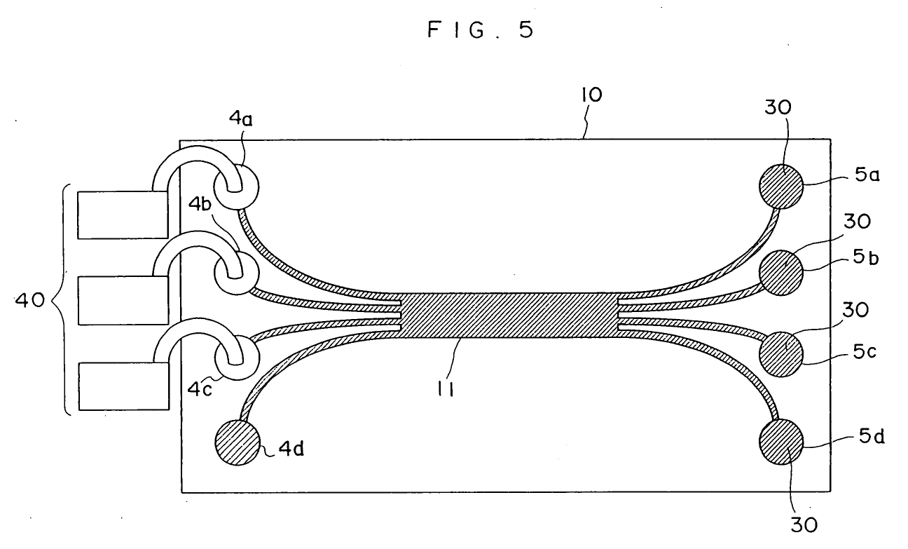

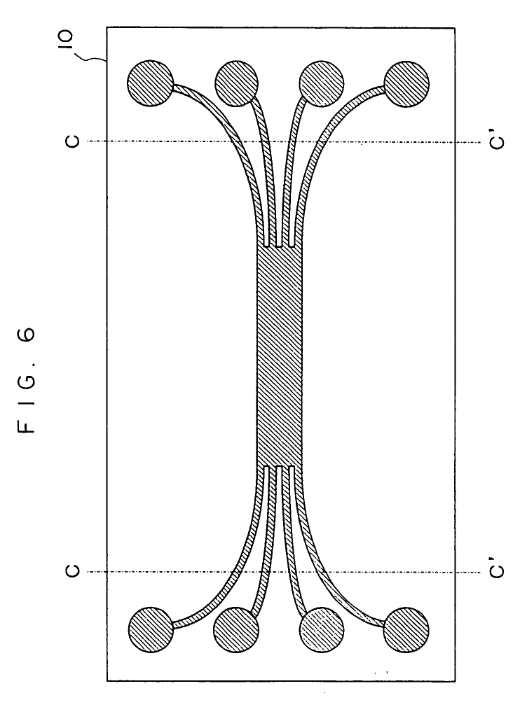

Next, in this state, the concave ends communicating with the through-holes 4a, 4b and 4c, respectively, are opened and used as resin outlets and the through-holes 5a, 5b, 5c and 5d are newly filled with the curable resin 30 which is to be a core, whereby the curable resin 30 is brought into contact with the concave ends at which the through-holes 5a, 5b, 5c and 5d communicate with the corresponding branched concave portion as shown in FIG. 5. Then, sucking by a suction unit 40 is restarted. This makes it possible to fill the entire of the concave portion with the core-forming curable resin as shown in FIG. 6. At this time, when the through-holes 5a, 5b, 5c, 5d and 4d become empty before the branched concave portions communicating with the through-holes 4a, 4b and 4c have been filled with the resin, the resin can be supplied to any of the through-holes 5a, 5b, 5c, 5d and 4d and the through-holes which are not being used for the resin supply and suction can be closed.

In the invention, at least one concave end is used as the resin inlet. When a resin is introduced through the above-mentioned process, it is preferable to use, as resin inlets, the concave ends of the branched concave portions which are formed at one side of the branch junction and have the same length from the viewpoints of prevention of resin waste and decreasing of cost.

The pressure in the suction is preferably in the range of from 0.1 to 100 kPa and more preferably in the range of from 1 to 50 kPa. The degree of the reduced pressure is determined in consideration of the time and labor necessary for reducing pressure, a filling speed, a pressure (having an influence on the life of the mold) applied to the mold and the like.

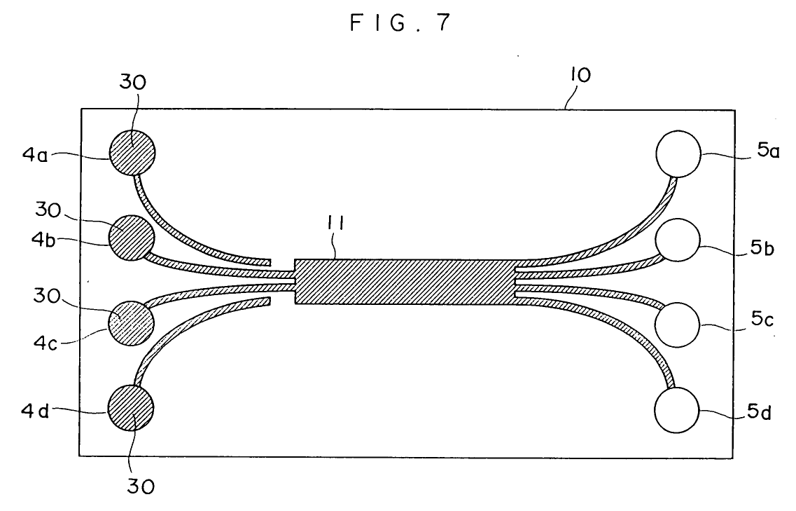

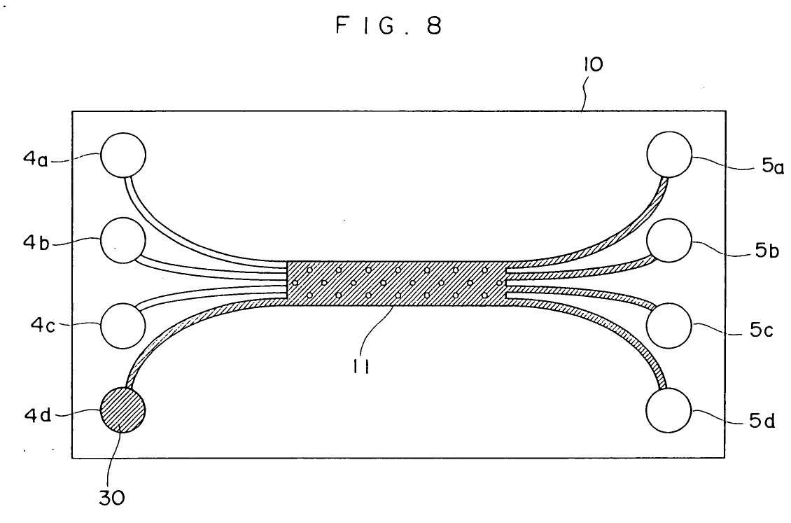

Unlike the above process, if the curable resin 30 is introduced from through-holes 4a, 4b, 4c and 4d and is sucked from the through-holes 5a, 5b, 5c and 5d, longer branched concave portions communicating with the through-holes 4a and 4d are not filled completely and space which is not filled with the resin are formed therein as shown in FIG. 7. It is difficult to fill the space.

Meanwhile, if the curable resin 30 is introduced from the through-hole 4d and is sucked from the through-holes 5a, 5b, 5c and 5d while the through-holes 4a, 4b and 4c are left open, air is resultantly introduced into the resin in the branch junction 11. As a result, voids are formed in the concave portion, causing defects of the waveguide obtained after the resin is cured. It is difficult to remove the voids.

As the core-forming curable resin, resins such as a radioactive ray-curable resin, an electron beam-curable resin or a thermosetting resin may be used. Among these resins, an ultraviolet ray-curable resin or a thermosetting resin is preferably used.

As the core-forming ultraviolet ray-curable or thermosetting resin, an ultraviolet ray-curable or thermosetting monomer or oligomer or a mixture of the monomer and oligomer is preferably used. Moreover, the ultraviolet ray-curable resin is preferably an epoxy type, a polyimide type or an acryl type ultraviolet ray-curable resin.

It is necessary for the core-forming curable resin to have a low viscosity enough to completely fill the concave portion of the mold therewith. The viscosity of the curable resin is preferably 10 to 2000 mpa•s, more preferably 20 to 1000 mpa•s and still more preferably 30 to 700 mpa•s from the viewpoints of a filling speed, a better core shape and a reduced optical loss.

When the viscosity of the curable resin is decreased by adding a solvent to the curable resin, the difference between the volume of the curable resin before solidifying and that of the solidified curable resin is large. Moreover, after the curable resin is solidified, the original shape of the convex portion of the master plate cannot be reproduced highly precisely as mentioned above. Therefore, it is necessary to select, as the core-forming curable resin, a material which is free from solvents and has as small volume change as possible.

In addition, the difference between the volume of the curable resin before curing and that after curing must be small in order to highly precisely reproduce the original shape of the convex portion of the master plate corresponding to an optical waveguide core. For example, a decrease in the core volume causes waveguide loss. Therefore, the difference between the volume of the curable resin before curing and that after curing is preferably as small as possible, and is preferably 10% or less and more preferably in the range of 0.01 to 4%. The addition of a solvent to the curable resin so as to decrease the viscosity Of the curable resin increases the above difference. Therefore, when the concave portion can be completely filled with the curable resin without using a solvent, disuse of a solvent is preferable.

A polymer may be added to the core-forming curable resin in order to decrease the difference (shrinkage) between the volume of the core-forming curable resin before curing and that after curing. The polymer preferably has compatibility with the core-forming curable resin and no adverse influence on the refractive index, elastic modulus and transmitting characteristics of the core-forming curable resin. The addition of the polymer makes it possible not only to decrease the above difference but also to precisely control the viscosity and the glass transition temperature of the curable resin. Examples of the polymer include, but are not limited to, an acrylic polymer, a methacrylic acid polymer and an epoxy polymer.

It is useful to heat the core-forming curable resin to be introduced from the resin inlet of the mold so as to decrease the viscosity thereof, in addition to the aforementioned pressure reduction of the system to accelerate the filling speed.

-Curing of Introduced Curable Resin-

Next, the core-forming curable resin in the mold is cured.

In order to cure the introduced curable resin 30, an ultraviolet lamp, an ultraviolet LED, an UV radiation device or the like is used. Moreover, when a thermosetting resin is introduced, the resin is heated in an oven or the like to cure the thermosetting resin.

The refractive index of the cured product of the core-forming curable resin is preferably in the range of from 1.20 to 1.60 and more preferably in the range of from 1.4 to 1.6. At least two curable resins are used such that the resultant cured products have different refractive indexes which are within the above range.

It is necessary that the refractive index of the cured product of the core-forming curable resin be larger than that of the film substrate as a clad. The difference between the refractive index of the core and that of the clad is preferably 0.02 or more and more preferably 0.05 or more. Accordingly, the refractive index of the curable resin is preferably 1.52 or more and more preferably 1.55 or more because many film substrates highly adhesive to the curable resin have a refractive index close to 1.50.

-Separating of Clad Substrate with Core from Mold-

After the resin is cured, the mold is separated from the resultant. However, when the mold 10 is made of PDMS, which has a low refractive index of about 1.43, it may be used as the clad layer as it is. In this case, the mold 10 is unnecessary to remove. Moreover, the measures to prevent the cured ultraviolet ray-curable resin or thermosetting resin from separating from the PDMS mold and to prevent a low-refractive index film which is a clad substrate from separating from the PDMS mold brought into close contact with the film is necessary.

-Formation of Clad Layer-

Next, a clad layer is formed on the surface of the clad substrate having the core. However, when the mold is used as the clad layer, this step is omitted.

-Removing of Unnecessary Portions of Cured Resin-

Thereafter, the resultant is cut along the dicing lines C-C′ to remove unnecessary portions of the cured resin which are or were confined in the through-holes to complete an optical waveguide.

Device for Producing Polymeric Optical Waveguide

The device for producing a polymeric optical waveguide according to the invention is preferably used in the method for producing a polymeric optical waveguide according to the invention.

The structure of the device of the invention will be hereinafter explained.

The device for producing a polymeric optical waveguide has a resin supply unit, a suction unit, and at least one movable lid. The device may further have a curing unit and a dicing unit.

One embodiment of the device of the invention has a resin supply unit, a suction unit and movable lids shown in FIG. 4. The mold used in the device is one shown in FIG. 1 and a clad substrate has been brought into close contact with the mold. The resin supply unit has a supply pipe and the supply pipe is attached to at least one through-hole in the mold communicating with a concave end serving as a resin inlet and supplies a resin to bring the concave end serving as the resin inlet with the resin and, when the resin is being sucked, continues the resin supply. However, the structure of the resin supply unit is not limited to this. For example, the resin supply unit can drip a resin solution into a fine hole or can have a fitting portion which can be moved vertically and fit into the through-hole communicating with a concave end used as a resin inlet.

The suction unit has a pump and a vacuum pipe communicating with the pump and the vacuum pipe is attached to at least one through-hole in the mold communicating with a concave end serving as a resin outlet which is provided opposite the resin inlet in order to reduce the internal pressure of the concave portion communicating with the through-hole into which the vacuum pipe is inserted.

The movable lid is a pin which can be tightly fit into the through-holes which are not being involved in the introduction and suction of the curable resin. However, the movable lid may be a film which is adhered only to the through-hole to be closed. The movable lid is attached to and closes the through-holes to be closed when the resin is being introduced and sucked into the concave portion of the mold, and detached therefrom when the concave portion has been filled with the resin.

The curing unit can be an ultraviolet lamp, an ultraviolet LED, a UV radiation unit or the like, when the core-forming curable resin is an ultraviolet ray-curable resin. When the core-forming curable resin is a thermosetting resin, the curing unit is a heater such as an oven.

The dicing unit can be a dicer (dicing member).

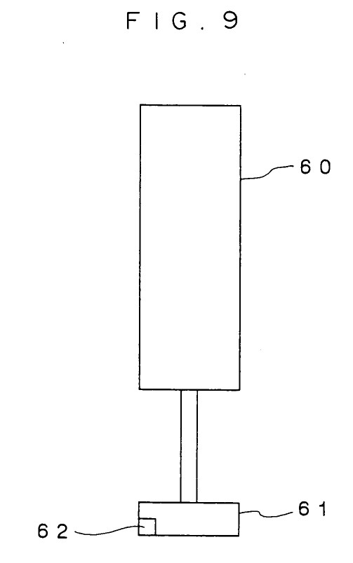

Another embodiment of the device of the invention is the same as the device shown in FIG. 4 except that the mold which is used in the device and with which a clad substrate has been brought into close contact is one shown in FIG. 10 and the resin supply unit has a structure shown in FIG. 9 and also serves as movable lids and the suction unit has a structure described later.

A resin supply unit 60 shown in FIG. 9 has a fitting portion 61 which is provided below the main body of the resin supply unit 60 and which can be moved horizontally and vertically and fit into the through-hole 15. The fitting portion 61 has a resin outlet 62 which is provided such that the resin outlet communicates with a concave end serving as a resin inlet when the fitting portion 61 is inserted into the through-hole 15.

The suction unit has a fitting portion which can be moved horizontally and vertically, rotated and fit into the through-hole and which has suction ports. The suction ports face branched concave ends serving as resin outlets when the fitting portion is inserted into the through-hole. The suction ports can be opened and closed, so that the fitting portion also serves as movable lids.

When a mold brought into close contact with a clad substrate is conveyed and aligned just under the device, the fitting portion 61 is moved downward and fit into one through-hole 15 and the resin outlet 62 can be aligned with the specified concave end such that the resin outlet communicates with the concave end serving as a resin inlet.

At this time, the fitting portion of the suction unit is also moved downward and fit into the other through-hole 15 and desired suction ports are opened and communicate with the concave ends serving as resin outlets and, if any, the other suction ports are closed. In other words, the suction of the concave ends serving as resin outlets are conducted simultaneously or successively.

Then, the resin supply unit can supply a resin from the resin outlet of the resin supply unit only to the concave end while the fitting portion 61 closes the remaining concave ends to prevent the resin from being introduced into the adjacent concave end. At this time, the suction unit sucks the resin. When desired portions of the concave portion of the mold have been filled with the resin, the fitting portion 61 and the fitting portion of the suction unit are moved upward. Then, the fitting portion of the suction unit and the fitting portion 61 are moved horizontally such that the fitting portion of the suction unit is provided just above the through-hole 15 into which the fitting portion of the resin supply unit was inserted. The fitting portion of the suction unit is rotated such that the suction ports face branched concave portions communicating with the through-hole when the fitting portion is inserted into the through-hole. The fitting portion is moved downward and inserted into the through-hole 15. Then, the suction ports which faces branched concave portions that have not been filled with the resin are opened and the other is closed. The suction unit sucks the resin. When the entire of the concave portion has been completely filled with the resin, the fitting portion of the suction unit is moved upward and the suction unit and the resin supply unit return to their initial positions. Then, the mold with the filled concave portion is conveyed to a curing zone.

The use of this device has an advantage in that the degree of freedom in designing a mold can be obtained. This is because one through-hole of the mold can correspond to branched concave portions which are formed at the same end of the branch junction.

The device can also save the time and labor necessary for the formation of the through-hole. Moreover, the resin supply unit can conduct simultaneously the alignment of the resin outlet and the closing of the through-hole which is not being used in the introduction of the resin and can enable the introduction of a resin to be efficiently carried out even when the optical waveguide to be produced has a core having branched portions whose diameters are small.

As mentioned above, the invention can produce an optical waveguide having a highly precise core shape and reduced waveguide loss by a simple method at low cost and can provide a flexible polymeric optical waveguide which has excellent mass-productivity and a high degree of freedom. In particular, the invention can shorten the time necessary for filling, improve production efficiency and also provide an optical waveguide free from defects, even when an waveguide to be produced is branched or long.

### EXAMPLES

The invention will be hereinafter explained in more detail by way of examples, however, the invention is not limited to the examples.

### Example 1

A thick film resist (SU-8, manufactured by Microchem Inc.) is applied to the surface of a silicon substrate having a diameter of 6 inch by a spin coating method. Then, the thick film resist is pre-baked at 80° C., subjected to pattern exposure through a photomask, and developed to form a convex portion having a length of 8 cm. Next, the developed film is post-baked at 120° C. to produce a master plate for forming an optical waveguide core. The master plate has a convex portion corresponding to a 4×4 type star coupler and having a total length of 6 cm. The convex portion has a branch junction and branched portions. The branch junction has a length of 3 cm and the cross-section of each of the branched portions is a 50 μm×50 μm square.

After n-hexane is applied to the surface of the master plate having the convex portion as a releasing agent, a thermosetting polydimethylsiloxane (PDMS) elastomer (SYLGARD 184, manufactured by Dow Corning Asia) is flowed into the master plate and heated at 120° C. for 30 minutes to solidify the elastomer. Then, the solidified elastomer is separated from the master plate to produce a mold precursor having a thickness of 5 mm and a concave portion corresponding to the convex portion having a square cross-section. Moreover, four independent through-holes each having a diameter of 3 mm and a cylindrical shape and extending parallel to the thickness of mold precursor are formed in the vicinity of each end portion of the mold precursor so as to expose branched portions of the concave portion and to form concave ends of the branched concave portions. Then, eight through-holes are formed in total. Thus, a mold shown in FIG. 1 is prepared. The pattern of the through-holes and an waveguide pattern extending to the through-holes are formed in advance in the resist pattern used in the pattern exposure.

The mold has a surface energy of 20 mN/m, a shore hardness of 45 and a root mean square roughness Rq of 0.05 μm. Next, the clad substrate, Arton Film manufactured by JSR Corporation and having a film thickness of 188 μm and a refractive index of 1.51 and larger than the mold is pushed against the mold so that the concave portion of the mold faces the clad substrate. Thereby, the both are brought into close contact with each other (see FIG. 2).

In this state, an epoxy type ultraviolet ray-curable resin (manufactured by NTT-AT) having a viscosity of 700 mPa•s is dripped into the through-hole 4d (see FIG. 2) of the PDMS mold by a syringe to thereby fill the through-hole 4d with the ultraviolet ray-curable resin and to bring the ultraviolet ray-curable resin into contact with, as a resin inlet, the concave end which communicates with the through-hole 4a. At this time, concave ends communicating with the through-holes 4a, 4b and 4c are closed by lids having a thickness of 3 mm and made of PDMS.

Next, the suction portions of a pump serving as a suction unit are attached to the through holes 5a, 5b, 5c and 5d. Then, the pressure is reduced to 20 kPa so as to suck the resin from the concave ends communicating with these through-holes while the resin is being supplied to the through-hole 4d. One minute later, the entire of the concave portion other than the branched concave portions extending from the branch junction to the through-holes 4a, 4b and 4c has been filled with the ultraviolet-ray curable resin (see FIG. 4).

Then, the suction portions are detached from the through-holes 5a, 5b, 5c and 5d and these through-holes are filled with the ultraviolet ray-curable resin by the syringe. Then, lids are removed from the through-holes 4a, 4b and 4c and the suction portions Of the suction unit are attached to these through-holes and the pressure is reduced. About 30 seconds later, filling the branched concave portions extending from the branch junction to the through-holes 4a, 4b and 4c with the resin has been completed (see FIG. 5).

In this state, UV light is irradiated to the ultraviolet ray-curable, resin confined in the PDMS mold through the mold at an intensity of 50 mW/cm² by a conveyer-united curing system manufactured by Ushio Inc. for 10 minutes to solidify the resin. Then, the PDMS mold is separated from the resultant in which a cured resin layer and the clad substrate (Arton Film) are integrated. The core has the same shape as the convex portion of the master plate and is free of defects. The refractive index of the core is 1.54.

Further, an ultraviolet ray-curable resin manufactured by NTT-AT and having a refractive index of 1.51 which is the same as that of Arton Film is applied to the core-formed surface of the Arton Film. Then, UV light is applied to the applied resin at an intensity of 50 mW/cm² for 10 minutes to solidify the resin, thereby forming a clad layer having a film thickness of 50 μm. The both ends of the resultant in which the clad substrate, the clad layer and the cured resin layer are integrated are cut by a dicer to remove unnecessary portions which were contained in the through-holes. Thus, a flexible polymeric optical waveguide is formed.

The polymeric optical waveguide having the above-mentioned branched structure has an insertion loss of 10 dB and a branch ratio of 1 dB (see FIG. 6)

### Example 2

A mold shown in FIG. 10 is prepared in the same manner as the preparation of the mold used in Example 1, except that a cylindrical through-hole having a diameter of 3 mm is formed at each end of the mold. As a result, two through-holes are formed in total and each through-hole communicates with four branched portions formed at the same end of the branch junction. Thus, the outer end of each branched portion communicating with the corresponding through-hole is a concave end.

Next, one concave end (one of concave ends communicating with the through-hole 4a shown in FIG. 2) is used as a resin inlet. The concave end is referred to as a concave end X hereinafter. Moreover, a dispenser which has the same structure of the resin supply unit shown in FIG. 9 is used for introducing the resin. The dispenser has a fitting portion which can be fit into the through-hole. The fitting portion has a resin outlet corresponding to the concave end X which serves as the resin inlet. The fitting portion also serves as a movable lid. When the fitting portion is inserted to the through-hole 4a, the resin outlet of the fitting portion is aligned and communicates with the concave end x and the fitting portion closes the other concave ends communicating with the through-hole 4a, enabling the introduction of the resin only from the concave end X.

A branched waveguide is prepared in the same manner as in Example 1, except that the through-hole 4a is filled with the ultraviolet ray-curable resin by using the dispenser to bring the concave end X into contact with the ultraviolet ray-curable resin, and that a suction unit having a fitting portion having a suction port which can be closed and opened with respect to each concave end is used.

The polymeric optical waveguide having the branched structure has an insertion loss of 10 dB and a branch ratio of 1 dB.

This method can more reduce the use amount of Arton Film serving as the clad substrate than in Example 1 because more patterns can be embedded in a PDMS mold having the same area.

### Comparative Example 1

A branched waveguide is prepared in the same manner as in Example 1, except that the through-holes 4a, 4b and 4c are not closed. In the branched waveguide, much air is contained in the ultraviolet ray-curable resin in the branch junction of a star coupler, and thereby the filling condition of the branch junction with the ultraviolet ray-curable resin is bad.

The produced optical waveguide is evaluated in the same manner as in Example 1 and undesirably has an insertion loss of 20 dB, which is much larger than that in Example 1 or 2.

1. A method for producing a polymeric optical waveguide the method comprising:
preparing a mold having, on a surface thereof, a concave portion for forming a core;
bringing a clad substrate into close contact with the surface of the mold having the concave portion;
filling the concave portion with a core-forming curable resin; and
curing the core-forming curable resin;
wherein the concave portion has branched concave portions and a branch junction, and each of the branched concave portions has, as a concave end, one end which is exposed, and the branch junction has at least one end thereof communicating with the other end of each of the branched concave portions; the filling is conducted by bringing the core-forming curable resin into contact with, as a resin inlet or inlets, one of the concave ends or at least two of the concave ends of the branched concave portions disposed at a same side of the mold and having the same length, using, as a resin outlet or outlets, at least one concave end disposed opposite the resin inlet or inlets, closing a remaining concave end or ends in an arbitrary order; supply the core-forming curable to the resin inlet or inlets and sucking the core-forming curable resin from the resin outlet or outlets to fill a part of the concave portion with the core-forming curable resin; opening the closed concave end or ends; and sucking the core-forming curable resin from the opened concave end or ends to fill a remaining part of the concave portion with the core-forming curable resin.

2. A method for producing a polymeric optical waveguide according to claim 1, wherein the branched concave portions include first branched concave portions communicating with one end of the branch junction and second branched concave portions communicating with the other end of the branch junction.

3. A method for producing a polymeric optical waveguide according to claim 2, wherein the mold further has, at an end portion thereof at which the first branched concave portions are provided, at least one first through-hole which opens at the other surface of the mold and, at the other end portion thereof, at least one second through-hole which opens at the other surface of the mold, and the first branched concave portions communicate with one of the at least one first through-hole, and the second branched concave portions communicate with one of the at least one second through-hole; bringing the core-forming curable resin into contact with the resin inlet or inlets is conducted by filling at least one of the at least one first through-hole with the core-forming curable resin; and, before sucking the core-forming curable resin from the opened concave end or ends, the at least one second through-holes is filled with the core-forming curable resin.

4. A method for producing a polymeric optical waveguide according to claim 3, wherein the first and second through-holes are disposed parallel to the thickness of the mold.

5. A method for producing a polymeric optical waveguide according to claim 1, wherein the entire of the resin inlet or inlets is brought into contact with the core-forming curable resin in bringing the core-forming curable resin into contact with the resin inlet or inlets.

6. A method for producing a polymeric optical waveguide according to claim 1, further comprising: removing the mold, forming a clad layer on the surface of the clad substrate having a core, and cutting both ends of the clad substrate.

7. A method for producing a polymeric optical waveguide according to claim 5, further comprising: cutting both ends of the clad substrate.

8. A device for producing a polymeric optical waveguide, the device comprising:
a resin supply unit for supplying a core-forming curable resin into a concave portion of a mold brought into close contact with a clad substrate;
a movable lid; and
a suction unit for reducing an internal pressure of the concave portion;
wherein the concave portion has branched concave portions and a branch junction, and each of the branched concave portions has, as a concave end, one end which is exposed, and the branch junction has at least one end thereof communicating with the other end of each of the branched concave portions; the resin supply unit is to be attached to one of the concave ends or at least two of the concave ends of the branched concave portions disposed at a same side of the mold and having the same length; the suction unit is to be attached to at least one of the concave ends at the other side of the mold, and the movable lid is to be attached to a remaining concave end or ends.

9. A device for producing a polymeric optical waveguide according to claim 8, further comprising a curing unit.

10. A device for producing a polymeric optical waveguide according to claim 8, wherein the branched concave portions include first branched concave portions communicating with one end of the branch junction and second branched concave portions communicating with the other end of the branch junction, and the mold further has, at an end portion thereof at which the first branched concave portions are provided, a first through-hole which is disposed parallel to the thickness of the mold and, at the other end portion thereof, a second through-hole which is disposed parallel to the thickness of the mold, and the first branched concave portions communicate with the first through-hole, and the second branched concave portions communicate with the second through-hole; and the resin supply unit has a fitting portion, and the fitting portion can be tightly fit into the first through-hole and has a resin outlet, and, when the fitting portion is inserted into the first through-hole, the resin outlet communicates with one of the concave ends communicating with the first through-hole and the fitting portion closes, as the movable lid, the other of the concave ends communicating with the first through-hole.

11. A device for producing a polymeric optical waveguide according to claim 10, wherein the suction unit has a fitting portion, and the fitting portion can be tightly fit into the second through-hole and has suction ports which can be closed and opened, and, when the fitting portion is inserted into the second through-hole, the suction ports face the concave ends communicating with the second through-hole.
